(19) United States
(12) Patent Application Publication
(10) Pub. No.: US 2005/0144402 A1
(43) Pub. Date: Jun. 30, 2005

(54) Method, system, and program for managing virtual memory

(76) Inventor: Harlan T. Beverly, McDade, TX (US)

Correspondence Address: KONRAD RAYNES & VICTOR, LLP, Suite 210, 315 S. Beverly Drive, Beverly Hills, CA, 90212, US

(21) Appl. No.: 10/747,920

(22) Filed: Dec. 29, 2003

(51) Int. Cl. G06F 12/08

(52) U.S. Cl. 711/152; 711/203

(57) ABSTRACT

Provided are a method, system, and program for managing virtual memory designated for use by a module such as a data send and receive agent. In one embodiment, virtual memory addresses intended for use by the module are designated as being within reserved portions and unreserved portions. Virtual memory addresses of the unreserved portion are mapped to physical memory to provide memory buffers which may be allocated to various users of the module in response to user requests. Virtual memory addresses in the reserved portion are not allocated to module users. The respective sizes of the reserved and unreserved portions may change, depending upon usage of the unreserved portions by the module users and needs of other modules and components of the system.

### BACKGROUND OF THE INVENTION

1. Field of the Invention

The present invention relates to a method, system, and program for managing virtual memory.

2. Description of the Related Art

In a network environment, a network adapter on a host computer, such as an Ethernet controller, Fibre Channel controller, etc., will receive Input/Output (I/O) requests or responses to I/O requests initiated from the host. Often, the host computer operating system includes a device driver to communicate with the network adapter hardware to manage I/O requests to transmit over a network. The host computer may also implement a protocol which packages data to be transmitted over the network into packets, each of which contains a destination address as well as a portion of the data to be transmitted. Data packets received at the network adapter are often stored in a packet buffer in the host memory. A transport protocol lay can process the packets received by the network adapter that are stored in the packet buffer, and access any I/O commands or data embedded in the packet.

For instance, the computer may implement the Transmission Control Protocol (TCP) and Internet Protocol (IP) to encode and address data for transmission, and to decode and access the payload data in the TCP/IP packets received at the network adapter. IP specifies the format of packets, also called datagrams, and the addressing scheme. TCP is a higher level protocol which establishes a connection between a destination and a source. Another protocol, Remote Direct Memory Access (RDMA) establishes a higher level connection and permits, among other operations, direct placement of data at a specified memory location at the destination.

A device driver, application or operating system can utilize significant host processor resources to handle network transmission requests to the network adapter. One technique to reduce the load on the host processor is the use of a TCP/IP Offload Engine (TOE) in which TCP/IP protocol related operations are implemented in the network adapter hardware as opposed to the device driver or other host software, thereby saving the host processor from having to perform some or all of the TCP/IP protocol related operations.

Offload engines and other devices frequently utilize memory, often referred to as a buffer, to store or process data. Buffers have been implemented using physical memory which stores data, usually on a short term basis, in integrated circuits, an example of which is a random access memory or RAM. Typically, data can be accessed relatively quickly from such physical memories. A host computer often has additional physical memory such as hard disks and optical disks to store data on a longer term basis. These nonintegrated circuit based physical memories tend to retrieve data more slowly than the integrated circuit physical memories.

The operating system of a computer typically utilizes a virtual memory space which is often much larger than the memory space of the physical memory of the computer. FIG. 1 shows an example of a virtual memory space 50 and a short term physical memory space 52. The memory space of a long term physical memory such as a hard drive is indicated at 54. The data to be sent in a data stream or the data received from a data stream may initially be stored in noncontiguous portions, that is, nonsequential memory addresses, of the various memory devices. For example, two portions indicated at 10a and 10b may be stored in the physical memory in noncontiguous portions of the short term physical memory space 52 while another portion indicated at 10c may be stored in a long term physical memory space provided by a hard drive as shown in FIG. 2. The operating system of the computer uses the virtual memory address space 50 to keep track of the actual locations of the portions 10a, 10b and 10c of the datastream 10. Thus, a portion 50a of the virtual memory address space 50 is mapped to the actual physical memory addresses of the physical memory space 52 in which the data portion 10a is stored. In a similar fashion, a portion 50b of the virtual memory address space 50 is mapped to the actual physical memory addresses of the physical memory space 52 in which the data portion 10b is stored. Furthermore, a portion 50c of the virtual memory address space 50 is mapped to the physical memory addresses of the long term hard drive memory space 54 in which the data portion 10c is stored. A blank portion 50d represents an unassigned or unmapped portion of the virtual memory address space 50.

FIG. 2 shows an example of a typical translation and protection table (TPT) 60 which the operating system utilizes to map virtual memory addresses to real physical memory addresses. Thus, the virtual memory address of the virtual memory space 50a may start at virtual memory address 0X1000, for example, which is mapped to a physical memory address 8AEF000, for example of the physical memory space 52. The TPT table 60 does not have any physical memory addresses which correspond to the virtual memory addresses of the virtual memory address space 50d because the virtual memory space 50d has not yet been mapped to physical memory space.

In known systems, portions of the virtual memory space 50 may be assigned to a device or software module for use by that module so as to provide memory space for buffers. Typically, all of the virtual memory space assigned to the module is mapped to physical memory for use by that module. Some device or software modules maintain a memory allocation table such as the table 70 shown in FIG. 3 in which the allocation of virtual memory space to various users of the module is tracked using a memory allocation bitmap 72. Each user may be a software routine, or hardware logic or other task or process operating in or with the module. In the bitmap 72, each bit represents a buffer which may be allocated to a requesting user. The memory allocation table 70 of this example, represents a plurality of virtual memory spaces referred to in the table 70 as virtual memory partition A, partition B . . . partition N, respectively. Each partition A, B, . . . N is a contiguous virtual memory space containing a buffer for each bit of the bitmap represented in the adjoining row 72a, 72b, . . . 72n of the bitmap 72. The size of each buffer within a particular partition is typically fixed to a particular size. For example, partition A has 26 buffers (as represented by 26 bits of the bitmap 72a) in which each buffer has a size of 4 KB (four thousand bytes). Thus, the size of the entire virtual memory space partition A is 26 times 4 KB or 104 KB. The starting address of the virtual memory space partition A is 0X1000, for example, as indicated in FIG. 3.

In response to a request for buffer space of a particular size, a memory manager of the module managing the memory allocation table 72, locates the partition of partitions A, B, . . . N containing buffers of the appropriate size. Thus, for example, if a user requests allocation of a 1K buffer, the memory manager goes to partition B which contains 1K sized buffers, locates an available 1K buffer as represented by a 0 in the table 72 within the partition bitmap 72B, and changes the bit such as bit 76, for example, from a zero to a one, indicating that the 1K buffer represented by the bit 76 has now been allocated. The memory manager returns to the requesting user the address of the buffer represented by bit 76 which is 0X22000 in the example of FIG. 3.

When a user no longer needs a particular buffer, the user instructs the memory manager to free that buffer by providing to the memory manager the address of the buffer to be freed. Thus, for example, if the user provides to the memory manager the address 0x22000 discussed above, the memory manager goes to bit 76 which represents the buffer of partition B having that address and changes the bit from a one to a zero, indicating that the 1K buffer represented by the bit 76 is once again available.

Notwithstanding, there is a continued need in the art to improve the performance of memory usage in data transmission and other operations.

### BRIEF DESCRIPTION OF THE DRAWINGS

Referring now to the drawings in which like reference numbers represent corresponding parts throughout:

FIG. 1 illustrates prior art virtual and physical memory addresses of data of a datastream stored in memory;

FIG. 2 illustrates a prior art virtual to physical memory address translation and protection table;

FIG. 3 illustrates a prior art memory allocation table;

FIG. 4 illustrates one embodiment of a computing environment in which aspects of the invention are implemented;

FIG. 5 illustrates a prior art packet architecture;

FIG. 6 illustrates one embodiment of a data structure of a memory allocation table in accordance with aspects of the invention;

FIG. 7 illustrates one embodiment of operations performed to allocate memory in accordance with aspects of the invention;

FIG. 8 illustrates one embodiment of operations performed to increase unreserved memory in accordance with aspects of the invention;

FIG. 9 illustrates one embodiment of operations performed to free previously allocated memory in accordance with aspects of the invention;

FIG. 10 illustrates one embodiment of operations performed to increase reserved memory in accordance with aspects of the invention; and

FIG. 11 illustrates an architecture that may be used with the described embodiments.

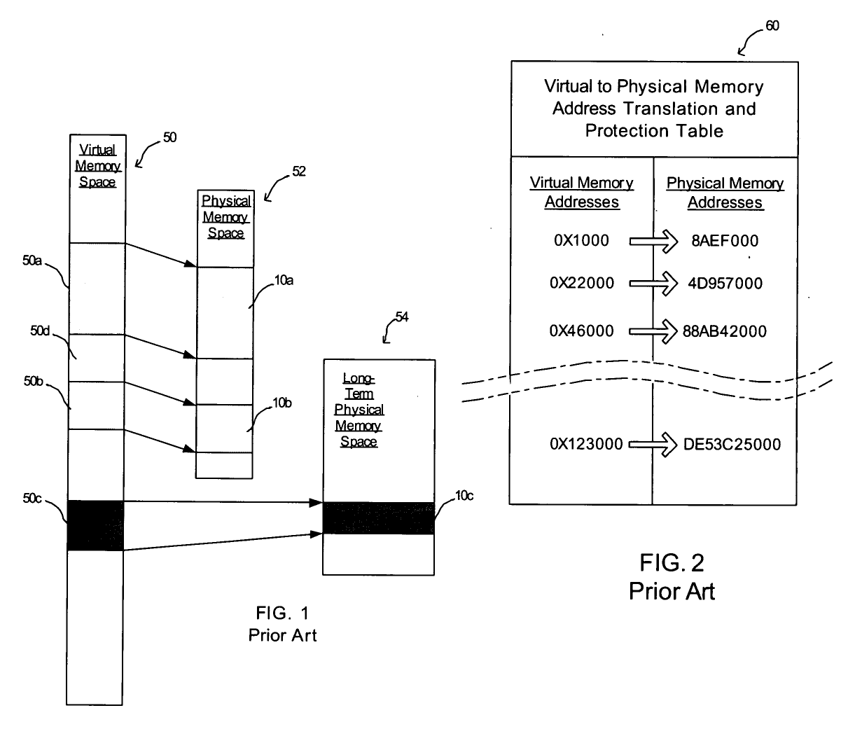

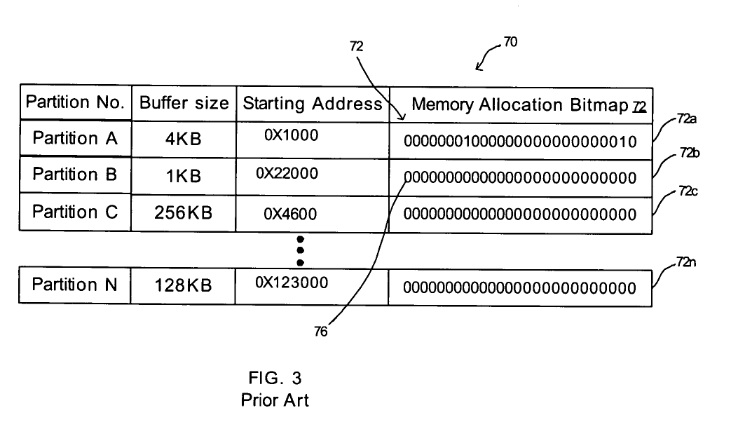

### DETAILED DESCRIPTION OF THE ILLUSTRATED EMBODIMENTS

In the following description, reference is made to the accompanying drawings which form a part hereof and which illustrate several embodiments of the present invention. It is understood that other embodiments may be utilized and structural and operational changes may be made without departing from the scope of the present invention.

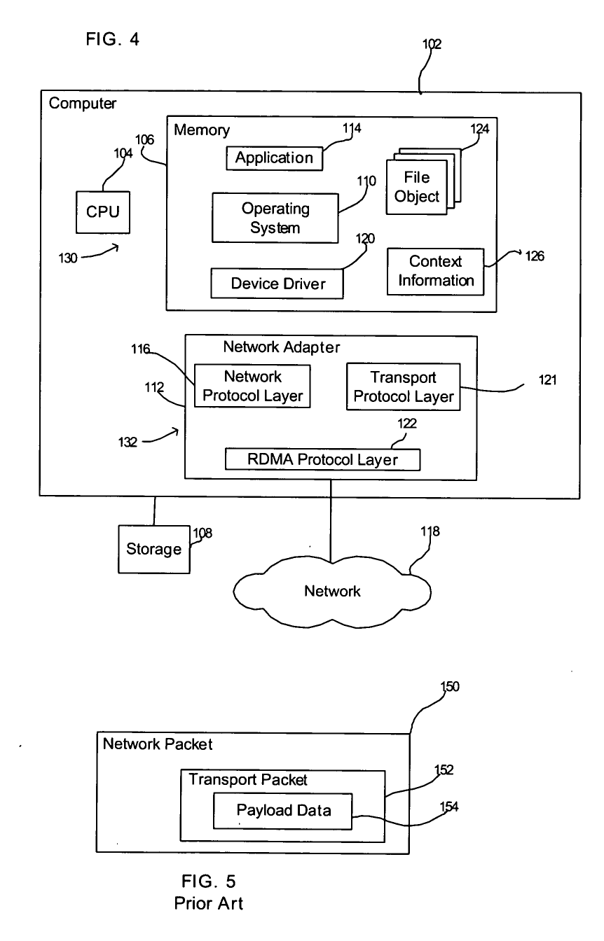

FIG. 4 illustrates a computing environment in which aspects of the invention may be implemented. A computer 102 includes one or more central processing units (CPU) 104 (only one is shown), a memory 106, nonvolatile storage 108, an operating system 110, and a network adapter 112. An application program 114 further executes in memory 106 and is capable of transmitting and receiving packets from a remote computer. The computer 102 may comprise any computing device known in the art, such as a mainframe, server, personal computer, workstation, laptop, handheld computer, telephony device, network appliance, virtualization device, storage controller, storage controller, etc. Any CPU 104 and operating system 110 known in the art may be used. Programs and data in memory 106 may be swapped into storage 108 as part of memory management operations.

The network adapter 112 includes a network protocol layer 116 to send and receive network packets to and from remote devices over a network 1118. The network 118 may comprise a Local Area Network (LAN), the Internet, a Wide Area Network (WAN), Storage Area Network (SAN), etc. Embodiments may be configured to transmit data over a wireless network or connection, such as wireless LAN, Bluetooth, etc. In certain embodiments, the network adapter 112 and various protocol layers may implement the Ethernet protocol including Ethernet protocol over unshielded twisted pair cable, token ring protocol, Fibre Channel protocol, Infiniband, Serial Advanced Technology Attachment (SATA), parallel SCSI, serial attached SCSI cable, etc., or any other network communication protocol known in the art.

A device driver 120 executes in memory 106 and includes network adapter 112 specific commands to communicate with a network controller of the network adapter 112 and interface between the operating system 110, applications 114 and the network adapter 112. The network controller can implement the network protocol layer 116 and can control other protocol layers including a data link layer and a physical layer which includes hardware such as a data transceiver.

In certain implementations, the network controller of the network adapter 112 includes a transport protocol layer 121 as well as the network protocol layer 116. For example, the network controller of the network adapter 112 can implement a TCP/IP offload engine (TOE), in which many transport layer operations can be performed within the offload engines of the transport protocol layer 121 implemented within the network adapter 112 hardware or firmware, as opposed to the device driver 120.

The transport protocol operations include packaging data in a TCP/IP packet with a checksum and other information and sending the packets. These sending operations are performed by an agent which may be implemented with a TOE, a network interface card or integrated circuit, a driver, TCP/IP stack, a host processor or a combination of these elements. The transport protocol operations also include receiving a TCP/IP packet from over the network and unpacking the TCP/IP packet to access the payload or data. These receiving operations are performed by an agent which, again, may be implemented with a TOE, a driver, a host processor or a combination of these elements.

The network layer 116 handles network communication and provides received TCP/IP packets to the transport protocol layer 121. The transport protocol layer 121 interfaces with the device driver 120 or operating system 110 or an application 114, and performs additional transport protocol layer operations, such as processing the content of messages included in the packets received at the network adapter 112 that are wrapped in a transport layer, such as TCP and/or IP, the Internet Small Computer System Interface (iSCSI), Fibre Channel SCSI, parallel SCSI transport, or any transport layer protocol known in the art. The transport offload engine 121 can unpack the payload from the received TCP/IP packet and transfer the data to the device driver 120, an application 114 or the operating system 110.

In certain implementations, the network controller and network adapter 112 can further include an RDMA protocol layer 122 as well as the transport protocol layer 121. For example, the network adapter 112 can implement an RDMA offload engine, in which RDMA layer operations are performed within the offload engines of the RDMA protocol layer 122 implemented within the network adapter 112 hardware, as opposed to the device driver 120 or other host software.

Thus, for example, an application 114 transmitting messages over an RDMA connection can transmit the message through the device driver 120 and the RDMA protocol layer 122 of the network adapter 112. The data of the message can be sent to the transport protocol layer 121 to be packaged in a TCP/IP packet before transmitting it over the network 118 through the network protocol layer 116 and other protocol layers including the data link and physical protocol layers.

The memory 106 further includes file objects 124, which also may be referred to as socket objects, which include information on a connection to a remote computer over the network 118. The application 114 uses the information in the file object 124 to identify the connection. The application 114 would use the file object 124 to communicate with a remote system. The file object 124 may indicate the local port or socket that will be used to communicate with a remote system, a local network (IP) address of the computer 102 in which the application 114 executes, how much data has been sent and received by the application 114, and the remote port and network address, e.g., IP address, with which the application 114 communicates. Context information 126 comprises a data structure including information the device driver 120, operating system 110 or an application 114, maintains to manage requests sent to the network adapter 112 as described below.

In the illustrated embodiment, the CPU 104 programmed to operate by the software of memory 106 including one or more of the operating system 110, applications 114, and device drivers 120 provides a host 130 which interacts with the network adapter 112. Accordingly, a data send and receive agent 132 includes the transport protocol layer 121 and the network protocol layer 116 of the network interface 112. However, the data send and receive agent 132 may be implemented with a TOE, a network interface card or integrated circuit, a driver, TCP/IP stack, a host processor or a combination of these elements.

FIG. 5 illustrates a format of a network packet 150 received at or transmitted by the network adapter 112. The network packet 150 is implemented in a format understood by the network protocol layer 116, such as such as the IP protocol. The network packet 150 may include an Ethernet frame that would include additional Ethernet components, such as a header and error checking code (not shown). A transport packet 152 is included in the network packet 150. The transport packet may 152 is capable of being processed by the transport protocol layer 121, such as the TCP protocol. The packet may be processed by other layers in accordance with other protocols including Internet Small Computer System Interface (iSCSI) protocol, Fibre Channel SCSI, parallel SCSI transport, etc. The transport packet 152 includes payload data 154 as well as other transport layer fields, such as a header and an error checking code. The payload data 152 includes the underlying content being transmitted, e.g., commands, status and/or data. The driver 120, operating system 110 or an application 114 may include a layer, such as a SCSI driver or layer, to process the content of the payload data 154 and access any status, commands and/or data therein.

As previously mentioned, portions of the virtual memory space 50 may be assigned to a device or software module for use by that module so as to provide memory space for buffers. Also, in prior systems, typically all of the virtual memory space assigned to a module is mapped to physical memory. In accordance with one embodiment which can improve memory resource management, a variable amount of physical memory may be mapped to the virtual memory space assigned to a particular module, depending upon the needs of various components of the system. The amount of physical memory space mapped to the assigned virtual memory space can subsequently be increased as the needs of the module increase. Conversely, the amount of physical memory mapped to the assigned virtual memory space can subsequently be decreased as the needs of the system outside the module increase.

In the illustrated embodiment, the physical memory mapped to the virtual memory space for use by the module can include portions of the host memory 106 and the long term storage 108. It is appreciated that the physical memory used by the module may be located in a variety of locations including motherboards, daughterboards, expansion cards, external cards, internal drives, external drives etc. Also, the module of the described example includes the data send and receive agent 132 and the driver 120. However, embodiments may be utilized by a variety of software and hardware resources for performing various functions of the system. In addition, each user may be of a class or other group of users which are capable of accessing memory, and can include one or more software routines, hardware logic or other tasks or processes operating in or in association with the module or other resource.

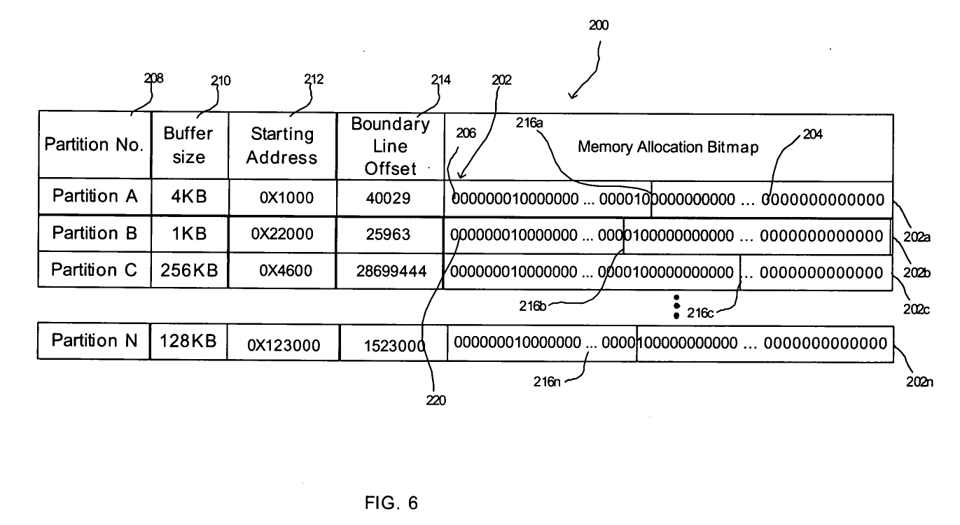

FIG. 6 shows an example of a memory allocation table 200 which can facilitate allocation of virtual memory space to various users of a data send and receive module where the amount of physical memory mapped to that virtual memory space varies. The table 200 includes a bitmap 202 of a virtual memory space assigned to the module, in which the assigned virtual memory space includes a reserved portion 204 (indicated by cross-hatching) and an unreserved portion 206 (lacking cross-hatching). In the unreserved portion 206 of the bitmap 202, each bit represents a buffer or other subportion which may be allocated to a requesting user. However, in the reserved portion 204, the system host 130 has reserved the memory space represented by each bit of the reserved portion 204. Thus, the buffers of the reserved portion 204 should not be allocated to users. However, as explained in greater detail below, as the needs of the users of the module grow, or the needs of the remaining system shrink, the unreserved portion 206 can be increased in size and the reserved portion 204 can be decreased in size, providing additional buffers available for allocation to users of the module. Conversely, as the needs of the remaining system increase or the needs of the module users decrease, the unreserved portion 206 can decrease in size and the portion 206 reserved by the system can increase. Thus, the reserved or unreserved status of each subportion of memory is conditional and may be switched as needs change.

The memory allocation table 200 of this example, represents a plurality of virtual memory spaces referred to in a field 208 in the table 200 as virtual memory partition A, partition B . . . partition N, respectively. Each partition A, B, . . . N is a contiguous virtual memory space containing a buffer for each bit of the bitmap 202 represented in the adjoining row 202a, 202b, . . . 202n of the bitmap 202. The size of each buffer within a particular partition may be fixed to a particular size which may be identified in a field 210. For example, partition A has 52 buffers (as represented by 52 bits of the bitmap 202a) in which each buffer has a size of 4 KB (four thousand bytes). Thus, the size of the entire virtual memory space partition A is 52 times 4 KB or 208 KB. The starting address of the virtual memory space partition A is 0X1000, for example, as indicated in a field 212 of the table 200 of FIG. 6. It is appreciated that the numbers of buffers and the size of each buffer represented by the bitmap 202 may vary, depending upon the application.

The boundary line between the unreserved portion 206 and the reserved portion 204 of the bitmap 202 can be defined by an offset (field 214) to the starting address of each partition A, B . . . N. Thus, the boundary line 216a between the unreserved portion 206 and the reserved portion 204 of the bitmap row 202A can be defined by an offset (such as 4029, for example) to the starting address 0X1000 of the partition A, for example. The boundary line 216a, 216b . . . 216n between the unreserved portion 206 and the reserved portion 204 of each partition A, B . . . N can be readily moved by changing the value in the offset field 214 of that particular partition.

Because of the variable nature of the table 200, the size of the virtual memory space represented by the table 200 can be relatively large. For example, the table 200 may represent 128 megabytes of virtual memory assigned to the module. Thus, when the table 200 is initially being populated, typically when the system is being booted, the driver 120 associated with the module can request a full 128 megabytes of virtual memory be allocated. However, the system host 130 need not map the 128 megabytes of virtual memory to a full 128 megabytes of physical memory. Instead, the system host 130 can map a lesser amount of physical memory depending upon the needs of the overall system.

In this illustrated embodiment, certain actions are described as being undertaken by a driver 120. It is appreciated that other software or hardware components may perform these or similar functions.

Those portions of the 128 megabytes of virtual memory space which are mapped by the system host 130 to physical memory may be indicated in a table similar to the TPT table indicated in FIG. 2. The driver 120 or other component may then examine the TPT table and populate the table 200 (FIG. 6), defining the buffer size (field 210) and the starting address (field 212) of each partition A, B . . . N. In addition, depending upon how much physical memory has been mapped by the system host 130 to the virtual memory space of each partition A, B . . . N, the driver 120 will set the offset field 214 to define the position of the boundary lines 216a, 216b . . . 216n between the unreserved portion 206 and the reserved portion 204 of each partition A, B . . . N. Thus, those contiguous portions of each bitmap 202a, 202b . . . 202n which have been mapped to physical memory for use by the module will be on the unreserved portion 206 side of the boundary line. Conversely, those contiguous portions of each bitmap 202a, 202b . . . 202n which have not been mapped to physical memory for use by the module will be on the reserved portion 204 side of the boundary lines 216a, 216b . . . 216n of the associated bitmap 202a, 202b . . . 202n, respectively. Since those portions of each bitmap 202a, 202b . . . 202n which are in the reserved portion 204 have not been mapped by the system host 130 to physical memory, that amount of physical memory is available for use by other components of the system.

In some systems, a portion of the virtual memory space may be “pinned” to short term memory such that the pinned virtual memory is generally precluded from being mapped to long term memory until it is subsequently “un-pinned.” In contrast, “un-pinned” virtual memory generally can be selectively mapped to either short term or long term physical memory, depending upon the needs of the system. In such systems, one method for a driver to reserve some virtual memory space, but not require that it be mapped to short term physical memory space would be to allocate “un-pinned” virtual memory for those portions of memory which need not have a direct physical mapping to short term memory. As a consequence, the allocated unpinned memory may be swapped to long term physical memory space and need not consume short term physical memory resources.

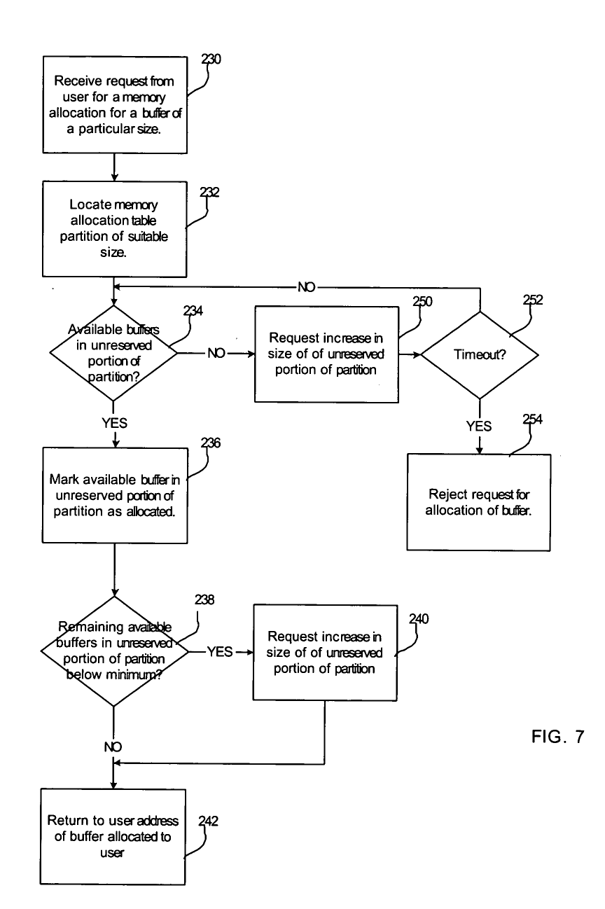

FIG. 7 shows operations of a memory manager of a driver 120, data send and receive agent 132 or other component of a module responding to a request (block 230) from a user of the module for buffer space of a particular size. The memory manager examines the memory allocation table 200 and locates (block 232) the partition of partitions A, B, . . . N containing buffers of the appropriate size. Thus, for example, if a user requests allocation of a 1K buffer, the memory manager can go to partition B which contains 1K sized buffers. The partition is then examined to determine (block 234) if there are any available buffers in the unreserved portion 206 of that partition. In one example, the memory manager locates an available 1K buffer as represented by a 0 in the unreserved portion 206 of the table 200 within the partition bitmap 202b, and changes (block 236) the bit such as bit 220, for example, from a zero to a one, indicating that the 1K buffer represented by the bit 220 has now been allocated.

If more than one buffer is available to be allocated in a particular partition, a number of different schemes may be used to select a buffer. For example, buffers may be selected sequentially from left to right (in order of increasing virtual addresses) or right to left (in order of decreasing virtual addresses), buffers may be selected every other one, etc.

In one embodiment, the memory manager may also determine (block 238) whether the number of remaining available (that is, unallocated) buffers in the unreserved portion 206 of the partition is at or below a particular minimum. If so, the memory manager can request (block 240) that the size of the unreserved portion 206 of that partition be increased, as discussed in greater detail below. The memory manager returns (block 242) to the requesting user the address of the buffer allocated to it. In the above example, the address 0X22000 of the buffer represented by the located bit 220 (the first buffer of the partition B) is returned to the user. The physical memory mapped by the TPT table to that buffer represented by the bit 220 is then used as a buffer by the user.

The bits in the reserved portion 204 of the partition bitmap 202b (that is, beyond the boundary line 216b as defined by the offset in the field 214 of the partition B) are ignored and are not allocated in response to a request from a user because the memory space represented by the bits in the portion 204 are reserved by the system memory. Thus the memory manager will not allocate to the user any of the buffers in the reserved portion 204.

If it is determined (block 234) in response to a buffer request that there are no available buffers in the unreserved portion 206 of that partition, the memory manager can request (block 250) that the size of the unreserved portion 206 of that partition be increased, as discussed in greater detail below. The partition may then be reexamined to determine (block 234) if there are any available buffers in the unreserved portion 206 of that partition. If additional buffers do not become available within a certain time period (block 252), the request for allocation of a buffer may be refused (block 254). It is appreciated that in other embodiments, another partition containing buffers larger than that requested may be examined (block 232) for available buffers.

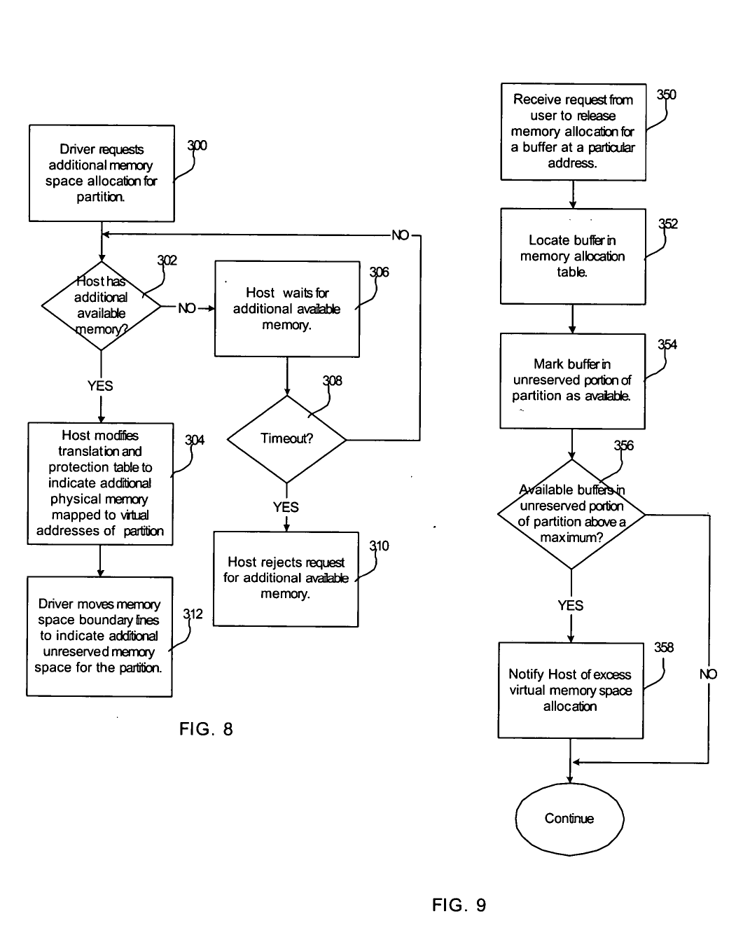

FIG. 8 shows operations of the driver 120 and host 130 to increase the size of the unreserved portion 206 of a particular buffer. This may be initiated, for example by the driver 120 making a request (block 300) for additional physical memory space for one of the partitions A, B . . . N of the virtual memory space allocated to a module. As previously mentioned, this may occur, for example, when the memory manager determines (block 238, FIG. 7) that the number of remaining available (that is, unallocated) buffers in the unreserved portion 206 of the particular partition is at or below a particular minimum.

In response to this request from the driver 120, the system host 130 can determine (block 302) whether there are additional memory resources available to service this request. If so, the system host 130 can modify (block 304) the TPT table to map additional physical memory to the virtual memory space of the partition. If additional memory resources are not immediately available, in one embodiment, the system host 130 can wait (block 306) for additional available memory resources. Once additional memory resources are available (block 302), the system host 130 can modify (block 304) the TPT table to map additional physical memory to the virtual memory space of the partition. In one embodiment, if additional resources do not become available within a particular time period (block 308), a timeout condition can occur and the request from the driver 120 can be refused (block 310).

One method for a driver to request that some portion of virtual memory be now mapped to a physical memory, is to request that that virtual memory become “pinned.” Once pinned, the additional portion of virtual memory will be mapped to short term physical memory.

After the request for additional physical memory is granted and the system host 130 modifies the TPT table to map addition physical memory to the virtual memory space of the partition, the driver 120 examines the TPT table and moves (block 312) the boundary line 216 between the unreserved portion 206 and the reserved portion 204 of the partition to indicate the additional memory space which can be allocated by the memory manager of the module in response to an allocation request by a user. The shift in the boundary line is indicated by increasing the value of the offset stored in the offset field 214 of the partition in the table 200 which increases the size of the unreserved portion 206 of the partition. In this manner, one or more subportions of the reserved portion 204 are converted to be a part of the enlarged unreserved portion 206. Thus, the reserved or unreserved status of each subportion of the memory portions 204, 206 is conditional and may be switched as needs change.

FIG. 9 shows operations of the memory manager when a user indicates that it no longer needs a particular buffer. The user sends an instruction to the memory manager (block 350) which instructs the memory manager to free, that is, unallocate a buffer by providing to the memory manager the address of the buffer to be freed. Thus, for example, if the user provides to the memory manager the address 0X22000 discussed above, the memory manager locates (block 352) bit 220 of the table 200 which represents the buffer of partition B having that address. The memory manager changes (block 354) the bit from a one to a zero, marking that 1K buffer represented by the bit 220 as once again available to be allocated to another user.

In one embodiment, the memory manager can examine the number of released and available buffers in the unreserved portion 206 of the partition and notify the host 130 if a particular partition is being underutilized. For example, the memory manager can determine (block 356) if the number of released and available buffers in the partition is above a maximum. If so, the host 130 can be notified (block 358) of the underutilization of that buffer. In response, the host 130 may reduce the size of the unreserved portion 206 of that partition as described in greater detail below.

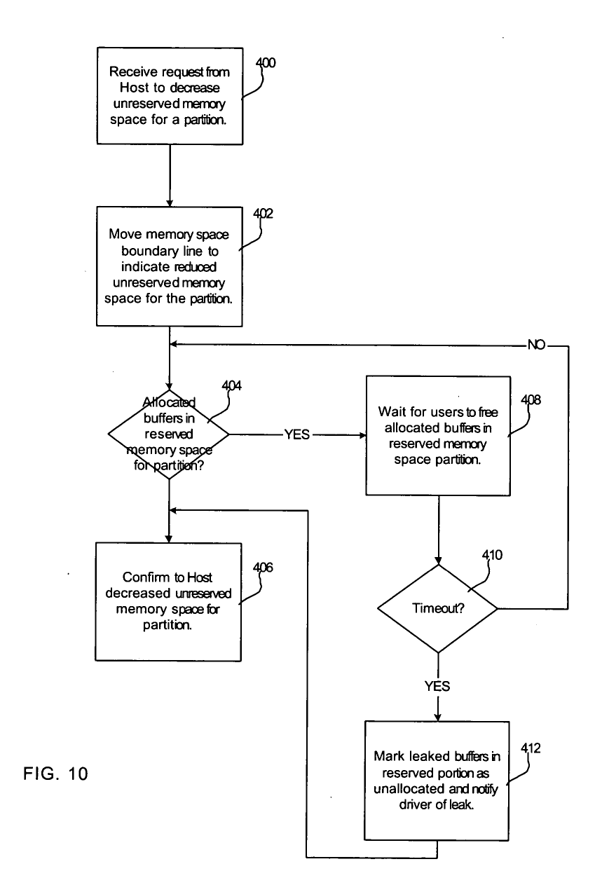

FIG. 10 shows operations of the driver 120 and host 130 to decrease the size of the unreserved portion 206 of a particular buffer and hence increase the size of the reserved portion 204 of the partition. This may be initiated, for example by the host 130 making a request (block 400) that less physical memory space be used for one of the partitions A, B . . . N of the virtual memory space allocated to a module. As previously mentioned, this may occur, for example, when the memory manager determines (block 356, FIG. 9) that a particular partition is being underutilized. Alternatively, the system host 130 may make a determination that the memory needs of other portions of the system have increased.

One method by which some portion of physical memory can be released, is to “un-pin” the associated virtual memory. Once un-pinned, the additional portion of virtual memory can be mapped to long term physical memory, freeing the short term memory for other uses.

In response to a request decrease the size of the unreserved portion 206 of a particular buffer and hence increase the size of the reserved portion 204 of the partition, the driver 120 or other component moves (block 402) the boundary line 216 between the unreserved portion 206 and the reserved portion 204 of the partition to indicate that less memory space can be allocated by the memory manager of the module in response to allocation requests by users. The shift in the boundary line is indicated by decreasing the value of the offset stored in the offset field 214 of the partition in the table 200 (FIG. 6) which increases the size of the reserved portion 204 of the partition and decreases the size of the unreserved portion 206 of the partition.

The driver 120 determines (block 404) whether there are any buffers that have been previously allocated in the newly reduced reserved portion 204 of the partition. If not, the driver 120 confirms (block 406) to the host 130 that reduction of the reserved portion has been completed for that partition. In response, the system host 130 can free additional memory resources to be available to other components of the system. Thus, for those buffers which were in effect moved from the unreserved portion 206 to the reserved portion 204, the physical memory which had been mapped to the virtual addresses of those buffers can be mapped in another table to other virtual addresses by the host 130 for use by those other system components.

In one embodiment, if the driver 120 determines (block 404) that there are one or more buffers that remain allocated in the newly enlarged reserved portion 204 of the partition, the driver 120 can wait (block 408) for users to instruct the memory manager to release those buffers now residing in the reserved portion 204 of the partition when no longer needed by the users to which the buffers were allocated. Once all of the buffers which were in effect moved from the unreserved portion 206 to the reserved portion 204 have been released, that is, are no longer allocated (block 404), the driver 120 can confirm (block 406) to the host 130 that reduction of the unreserved portion has been completed for that partition. In this manner, the unreserved portion 206 can be shrunk while the reserved portion 204 is enlarged, by converting one or more subportions of the unreserved portion 206 to be a part of the enlarged reserved portion 204. Thus, the reserved or unreserved status of each subportion of the memory portions 204, 206 is conditional and may be switched as needs change.

In one embodiment, if all of the buffers which were in effect moved from the unreserved portion 206 to the reserved portion 204 are not released, that is, one or more buffers remain allocated (block 404) after expiration of a particular time period (block 410), it can be assumed that those allocated buffers have “leaked” (that is, they have not released when no longer being used). If so, the memory manager can mark these buffers as unallocated (block 412) and optionally notify the driver of the leak. It is then confirmed (block 406) to the host 130 that reduction of the unreserved portion 206 has been completed for that partition. Alternatively, the request from the host 130 can be refused if all of the buffers which were in effect moved from the unreserved portion 206 to the reserved portion 204 are not released.

Additional Embodiment Details

The described techniques for managing memory may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

In the described embodiments, certain operations were described as being performed by the operating system 110, system host 130, device driver 120, or the network interface 112. In alterative embodiments, operations described as performed by one of these may be performed by one or more of the operating system 110, device driver 120, or the network interface 112. For example, memory operations described as being performed by the driver may be performed by the host.

In the described implementations, a transport protocol layer 121 was implemented in the network adapter 112 hardware. In alternative implementations, the transport protocol layer may be implemented in the device driver or host memory 106.

In the described embodiments, the packets are transmitted from a network adapter to a remote computer over a network. In alternative embodiments, the transmitted and received packets processed by the protocol layers or device driver may be transmitted to a separate process executing in the same computer in which the device driver and transport protocol driver execute. In such embodiments, the network adapter is not used as the packets are passed between processes within the same computer and/or operating system.

In certain implementations, the device driver and network adapter embodiments may be included in a computer system including a storage controller, such as a SCSI, Integrated Drive Electronics (IDE), Redundant Array of Independent Disk (RAID), etc., controller, that manages access to a nonvolatile storage device, such as a magnetic disk drive, tape media, optical disk, etc. In alternative implementations, the network adapter embodiments may be included in a system that does not include a storage controller, such as certain hubs and switches.

In certain implementations, the device driver and network adapter embodiments may be implemented in a computer system including a video controller to render information to display on a monitor coup led to the computer system including the device driver and network adapter, such as a computer system comprising a desktop, workstation, server, mainframe, laptop, handheld computer, etc. Alternatively, the network adapter and device driver embodiments may be implemented in a computing device that does not include a video controller, such as a switch, router, etc.

In certain implementations, the network adapter may be configured to transmit data across a cable connected to a port on the network adapter. Alternatively, the network adapter embodiments may be configured to transmit data over a wireless network or connection, such as wireless LAN, Bluetooth, etc.

The illustrated logic of FIGS. 7-10 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

FIG. 6 illustrates information used to manage memory space. In alternative implementation, these data structures may include additional or different information than illustrated in the figures.

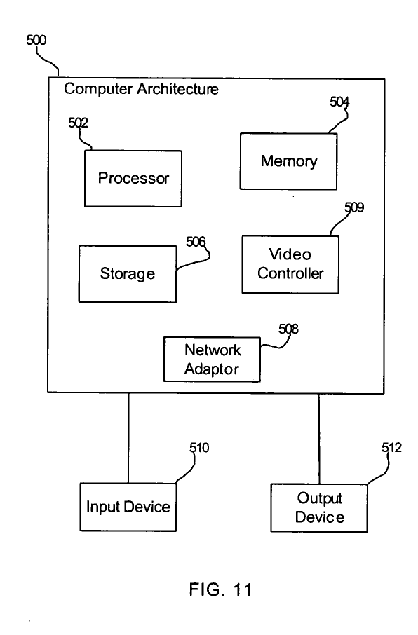

FIG. 11 illustrates one implementation of a computer architecture 500 of the network components, such as the hosts and storage devices shown in FIG. 4. The architecture 500 may include a processor 502 (e.g., a microprocessor), a memory 504 (e.g., a volatile memory device), and storage 506 (e.g., a nonvolatile storage, such as magnetic disk drives, optical disk drives, a tape drive, etc.). The storage 506 may comprise an internal storage device or an attached or network accessible storage. Programs in the storage 506 are loaded into the memory 504 and executed by the processor 502 in a manner known in the art. The architecture further includes a network adapter 508 to enable communication with a network, such as an Ethernet, a Fibre Channel Arbitrated Loop, etc. Further, the architecture may, in certain embodiments, include a video controller 509 to render information on a display monitor, where the video controller 509 may be implemented on a video card or integrated on integrated circuit components mounted on the motherboard. As discussed, certain of the network devices may have multiple network cards or controllers. An input device 510 is used to provide user input to the processor 502, and may include a keyboard, mouse, pen-stylus, microphone, touch sensitive display screen, or any other activation or input mechanism known in the art. An output device 512 is capable of rendering information transmitted from the processor 502, or other component, such as a display monitor, printer, storage, etc.

The network adapter 508 may be implemented on a network card, such as a Peripheral Component Interconnect (PCI) card or some other I/O card, or on integrated circuit components mounted on the motherboard.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended

1. A method, comprising:
designating a first portion of a virtual memory space as an unreserved portion which is conditionally accessible by a class of memory users which includes at least one memory user wherein said unreserved portion is mapped to physical memory space;
designating a second portion of said virtual memory space as a reserved portion which is conditionally unavailable for use by any memory user of said class of memory users; and
converting a subportion of one of said unreserved portion and said reserved portion to a subportion of the other of said unreserved portion and said reserved portion.

2. The method of claim 1 further comprising allocating a buffer subportion of the unreserved portion of said virtual memory space for use as a buffer memory by a memory user of said class of memory users.

3. The method of claim 2 wherein said allocating includes changing a bit of a bitmap representing said unreserved portion to indicate that said buffer subportion is allocated to a memory user.

4. The method of claim 3 further comprising subsequently unallocating said buffer subportion so that said buffer subportion is available to be allocated to a user of said class of memory users.

5. The method of claim 4 wherein said unallocating includes changing a bit of a bitmap representing said unreserved portion to indicate that said buffer subportion is available to be allocated to a user of said class of memory users.

6. The method of claim 1 wherein said converting includes converting a subportion of said unreserved portion to a subportion of said reserved portion.

7. The method of claim 1 wherein said converting includes converting a subportion of said reserved portion to a subportion of said unreserved portion.

8. The method of claim 1 wherein said reserved and unreserved portions are contiguous in said virtual memory space and the boundary between said reserved and unreserved portions is represented by a virtual memory address and wherein said converting includes changing the virtual memory address of the boundary.

9. The method of claim 1 wherein said class of memory users are users of a send and receive agent.

10. The method of claim 1 wherein said physical memory is a part of a host memory.

11. The method of claim 1 wherein said reserved portion is not mapped to physical memory space.

12. An article comprising a storage medium, the storage medium comprising machine readable instructions stored thereon to:
designate a first portion of a virtual memory space as an unreserved portion which is conditionally accessible by a class of memory users which includes at least one memory user wherein said unreserved portion is mapped to physical memory space;
designate a second portion of said virtual memory space as a reserved portion which is conditionally unavailable for use by any memory user of said class of memory users; and
convert a subportion of one of said unreserved portion and said reserved portion to a subportion of the other of said unreserved portion and said reserved portion.

13. The article of claim 12 wherein the storage medium further comprises machine readable instructions stored thereon to allocate a buffer subportion of the unreserved portion of said virtual memory space for use as a buffer memory by a memory user of said class of memory users.

14. The article of claim 13 wherein the machine readable instructions to allocate include machine readable instructions stored on the storage medium to change a bit of a bitmap representing said unreserved portion to indicate that said buffer subportion is allocated to a memory user.

15. The article of claim 14 wherein the storage medium further comprises machine readable instructions stored thereon to subsequently unallocate said buffer subportion so that said buffer subportion is available to be allocated to a user of said class of memory users.

16. The article of claim 15 wherein the machine readable instructions to unallocate include machine readable instructions stored on the storage medium to change a bit of a bitmap representing said unreserved portion to indicate that said buffer subportion is available to be allocated to a user of said class of memory users.

17. The article of claim 12 wherein the machine readable instructions to convert include machine readable instructions stored on the storage medium to convert a subportion of said unreserved portion to a subportion of said reserved portion.

18. The article of claim 12 wherein the machine readable instructions to convert include machine readable instructions stored on the storage medium to convert a subportion of said reserved portion to a subportion of said unreserved portion.

19. The article of claim 12 wherein said reserved and unreserved portions are contiguous in said virtual memory space and the boundary between said reserved and unreserved portions is represented by a virtual memory address and wherein the machine readable instructions to convert include machine readable instructions stored on the storage medium to change the virtual memory address of the boundary.

20. The article of claim 12 wherein said class of memory users are users of a send and receive agent.

21. The article of claim 12 wherein said physical memory is a part of a host memory.

22. The article of claim 12 wherein said reserved portion is not mapped to physical memory space.

23. A system, comprising:
a virtual memory space comprising a plurality of memory addresses;
a physical memory which includes data storage, said physical memory having a physical memory space comprising a plurality of physical memory addresses;
a processor coupled to the physical memory;
a network controller which includes a class of physical memory users which includes at least one physical memory user;
a data storage controller for managing Input/Output (I/O) access to the data storage; and
a device driver executable by the processor in the memory, wherein at least one of the device driver and the network controller is adapted to:
(i) designate a first portion of a virtual memory space as an unreserved portion which is conditionally accessible by said class of memory users wherein said unreserved portion is mapped to said physical memory space;
(ii) designate a second portion of said virtual memory space as a reserved portion which is conditionally unavailable for use by any memory user of said class of memory users; and
(iii) convert a subportion of one of said unreserved portion and said reserved portion to a subportion of the other of said unreserved portion and said reserved portion.

24. The system of claim 23 wherein at least one of the device driver and the network controller is further adapted to allocate a buffer subportion of the unreserved portion of said virtual memory space for use as a buffer memory by a memory user of said class of memory users.

25. The system of claim 24 further comprising a bitmap having a plurality of bits representing said unreserved portion and wherein said allocating includes changing a bit of said bitmap representing said unreserved portion to indicate that said buffer subportion is allocated to a memory user.

26. The system of claim 25 wherein at least one of the device driver and the network controller is further adapted to subsequently unallocate said buffer subportion so that said buffer subportion is available to be allocated to a user of said class of memory users.

27. The system of claim 26 wherein said unallocating includes changing a bit of a bitmap representing said unreserved portion to indicate that said buffer subportion is available to be allocated to a user of said class of memory users.

28. The system of claim 23 wherein said converting includes converting a subportion of said unreserved portion to a subportion of said reserved portion.

29. The system of claim 23 wherein said converting includes converting a subportion of said reserved portion to a subportion of said unreserved portion.

30. The system of claim 23 wherein said reserved and unreserved portions are contiguous in said virtual memory space and the boundary between said reserved and unreserved portions is represented by a virtual memory address and wherein said converting includes changing the virtual memory address of the boundary.

31. The system of claim 23 wherein at least one of the device driver and the network controller includes a send and receive agent which includes said class of memory users.

32. The system of claim 23 further comprising a host memory and said physical memory is a part of a host memory.

33. The system of claim 23 wherein said reserved portion is not mapped to said physical memory space.

34. The system of claim 23 for use with an unshielded twisted pair cable, said system further comprising an Ethernet data transceiver coupled to said network controller and said cable and adapted to transmit and receive data over said cable.

35. The system of claim 23 further comprising a video controller coup led to said processor.

36. A network adapter for use with a system which includes a virtual memory space comprising a plurality of memory addresses, a physical memory which includes data storage, said physical memory having a physical memory space comprising a plurality of physical memory addresses; the adapter comprising:
a class of physical memory users which includes at least one physical memory user;
wherein the network adapter is adapted to:
(i) designate a first portion of said virtual memory space as an unreserved portion which is conditionally accessible by said class of memory users wherein said unreserved portion is mapped to said physical memory space;
(ii) designate a second portion of said virtual memory space as a reserved portion which is conditionally unavailable for use by any memory user of said class of memory users; and
(iii) convert a subportion of one of said unreserved portion and said reserved portion to a subportion of the other of said unreserved portion and said reserved portion.

37. The adapter of claim 36 wherein the network adapter is further adapted to allocate a buffer subportion of the unreserved portion of said virtual memory space for use as a buffer memory by a memory user of said class of memory users.

38. The adapter of claim 37 further comprising a bitmap having a plurality of bits representing said unreserved portion and wherein said allocating includes changing a bit of said bitmap representing said unreserved portion to indicate that said buffer subportion is allocated to a memory user.

39. The adapter of claim 38 wherein the network adapter is further adapted to subsequently unallocate said buffer subportion so that said buffer subportion is available to be allocated to a user of said class of memory users.

40. The adapter of claim 36 wherein said reserved and unreserved portions are contiguous in said virtual memory space and the boundary between said reserved and unreserved portions is represented by a virtual memory address and wherein said converting includes changing the virtual memory address of the boundary.

41. The adapter of claim 36 wherein said reserved portion is not mapped to said physical memory space.
